(19) United States
(12) Patent Application Publication
(10) Pub. No.: US 2024/0188164 A1
(43) Pub. Date: Jun. 6, 2024

(54) MANAGING RADIO CONNECTIONS DURING EARLY DATA COMMUINICATION VIA A DISTRIBUTED BASE STATION

(71) Applicant: GOOGLE LLC, Mountain View, CA (US)

(72) Inventor: Chih-Hsiang Wu, Taoyuan City (TW)

(21) Appl. No.: 18/285,260

(22) PCT Filed: Apr. 1, 2022
(86) PCT No.: PCT/US22/23116

§ 371 Date: Oct. 1, 2023

Related U.S. Application Data
(60) Provisional application No. 63/200,899, filed on Apr. 1, 2021.

(51) Int. Cl. H04W 76/20; H04W 72/21; H04W 76/19

(52) U.S. Cl. CPC H04W 76/20; H04W 72/21; H04W 76/19

(57) ABSTRACT

A base station managing data communication with a UE by performing (1102) early data communication with the UE operating in an inactive state, determining (1104), during the early data communication, that the UE should transition to a connected state, and transmitting (1106), in response to the determining, to the UE, a message that causes the UE to transition to the connected state.

### FIELD OF THE DISCLOSURE

This disclosure relates generally to wireless communications and, more particularly, to communication of uplink and/or downlink data at a user equipment (UE) when the UE operates in an inactive or idle state associated with a protocol for controlling radio resources.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Generally speaking, a base station operating a cellular radio access network (RAN) communicates with a user equipment (UE) using a certain radio access technology (RAT) and multiple layers of a protocol stack. For example, the physical layer (PHY) of a RAT provides transport channels to the Medium Access Control (MAC) sublayer, which in turn provides logical channels to the Radio Link Control (RLC) sublayer, and the RLC sublayer in turn provides data transfer services to the Packet Data Convergence Protocol (PDCP) sublayer. The Radio Resource Control (RRC) sublayer is disposed above the PDCP sublayer.

The RRC sublayer specifies the RRC_IDLE state, in which a UE does not have an active radio connection with a base station; the RRC_CONNECTED state, in which the UE has an active radio connection with the base station; and the RRC_INACTIVE to allow a UE to more quickly transition back to the RRC_CONNECTED state due to Radio Access Network (RAN)-level base station coordination and RAN-paging procedures. In some cases, the UE in the RRC_IDLE or RRC_INACTIVE state has only one, relatively small packet to transmit. In these cases, the UE is in the RRC_IDLE or RRC_INACTIVE state can perform an early data transmission (also referred to herein as small data transmission) without transitioning to the RRC_CONNECTED state, e.g., by using techniques as specified in section 7.3 in 3GPP specification 36.300 v16.4.0.

In some scenarios, during early data communication with a UE operating in an inactive or idle state, a network node may receive a downlink (DL) data packet addressed to the UE. The DL data packet can arrive from a core network or an edge server, and may be associated with a certain quality of service (QOS) flow or an RB. It is not clear how the network node should process the DL data packet. As a result, the network node may simply drop the DL data packet.

More generally, it is not clear how a base station should cause the UE to transition to a connected state of the RRC protocol upon receipt of such a DL data packet, especially when the base station is implemented in a distributed manner.

### SUMMARY

A base station of this disclosure can determine that a UE should transition to the connected state in which the radio resource control connection between the UE and the base station is active, while the UE is performing early data communication. When implemented in a distributed manner, the CU obtains a radio configuration from the DU and transmits the radio configuration to the UE.

The CU can determine that the UE should transition to the connected state in response to receiving downlink data addressed to the UE optionally associated with a specific QoS or RB, an explicit command from the core network or an edge server, or a request from the UE, for example. Further, the CU can use different mechanisms for causing the UE to transition to the connected state, such as including an explicit indicator in an RRC message or initiating a paging procedure. Still further, the CU can obtain the radio configuration for the UE using a procedure for requesting a UE context from the DU or a procedure for modifying the UE context, for example.

One example embodiment of these techniques is a method in a CU of a distributed base station for managing data communication between a UE and a distributed unit (DU) of the distributed base station. The method includes performing early data communication with the UE; determining, during the early data communication, that the UE should have an active radio resource control connection with the DU; obtaining, from the DU, a radio configuration for the UE; and transmitting, via the DU, the radio configuration to the UE.

Another example embodiment of these techniques is a method in a DU of a distributed base station for facilitating uplink data communication between a UE and a CU of the distributed base station. The method includes receiving a control-plane message from the UE; determining whether the DU stores a context for the UE; selecting, based on the determining, a first or a second type of a DU-to-CU message; and transmitting, by the processing hardware to the CU, the control-plane message in the selected type of the DU-to-CU message.

Still another example embodiment of these techniques is a network node comprising hardware and configured to implement one of the methods above.

Another example embodiment of these techniques is a method in a UE for processing a paging request from RAN. The method includes receiving, from the RAN and when the UE does not have an active radio resource control connection with the RAN, a paging request during the early data communication, the request including an early data transmission (EDT) indication; in a first instance, in response to determining that the UE is initiating a procedure to transition to a connected state in which the radio resource control connection with the RAN is active: omitting, from a message responsive to the paging request, the EDT indication; in a second instance, in response to determining that the UE is not initiating the procedure to transition to the connected state: including, in the message, the EDT indication. The method further includes transmitting the message to the RAN.

### BRIEF DESCRIPTION OF THE DRAWINGS

FIG. 1A is a block diagram of an example system in which a distributed base station and/or a user equipment (UE) can implement the techniques of this disclosure for managing a radio connection of the UE during early data transmission (EDT);

FIG. 1B is a block diagram of an example base station including a central unit (CU) and a distributed unit (DU) of a distributed base station that can operate in the system of FIG. 1A;

FIG. 2A is a block diagram of an example protocol stack according to which the UE of FIGS. 1A-B can communicate with base stations;

FIG. 2B is a block diagram of an example protocol stack according to which the UE of FIGS. 1A-B can communicate with a DU and a CU of a base station;

FIG. 3A illustrates an example scenario in which a CU determines that the UE should transition to the connected state during early data communication, obtains a radio configuration for the UE from a DU, includes the radio configuration in a command to resume the radio connection, and transmits the command to the UE via the DU;

FIG. 3B illustrates an example scenario in which a CU determines that the UE should transition to the connected state during early data communication and transmits, to the UE, a release command including an explicit indication that the UE should transition to the connected state;

FIG. 3C illustrates an example scenario in which a CU determines that the UE should transition to the connected state during early data communication and initiates paging of the UE via the DU;

FIG. 3D illustrates an example scenario similar to that of FIG. 3B, but with the DU transmitting an explicit indication that the UE should transition to the connected state in a DL MAC PDU rather an RRC message;

FIG. 3E illustrates an example scenario in which a CU receives non-EDT DL data for the UE and transmits at least a portion of the DL data during the EDT procedure, and the UE requests that the RAN resume the radio connection;

FIG. 3F illustrates an example scenario in which a UE operating in an inactive state receives a paging request with an EDT indication but determines, in view of pending UL data, to nevertheless request that the RAN resume the radio connection;

FIG. 4A is a flow diagram of an example method for determining whether a CU should instruct a UE to transition to the connected state, in view of the type of downlink data the CU receives from the core network or an edge server;

FIG. 4B is a flow diagram of an example method for determining whether a CU should instruct a UE to transition to the connected state, in view of whether the core network explicitly requested this transition;

FIG. 5 is a flow diagram of an example method for transmitting DL data to the UE during early data communication, which can be implemented in a CU of this disclosure;

FIG. 6 is a flow diagram of an example method for processing DL data during early data communication, which can be implemented in a UE of this disclosure;

FIG. 7 is a flow diagram of an example method for obtaining radio resources for a UE when the CU causes the UE to transition to the connected state during early data communication, which can be implemented in a CU of this disclosure;

FIG. 8 is a flow diagram of an example method in a DU for selecting an uplink message for communication with a CU in view of whether the DU has a context for the UE;

FIG. 9 is a flow diagram of an example method in a CU for instructing the UE to transition to the connected state during early data communication;

FIG. 10 is a flow diagram of an example method in a UE for transitioning to the connected state after early data communication and continuing transmission in the connected state;

FIG. 11 is a flow diagram of an example method in a CU for instructing the UE to transition to the connected state as well as stop early data communication;

FIG. 12 is a flow diagram of an example method in a UE for transiting to the connected state and stopping early data communication in response to a message from the CU;

FIG. 13 is a flow diagram of an example method in a radio access network (RAN) for instructing the UE to transition to the connected state during early data communication;

FIG. 14 is a flow diagram of an example method in a UE for stopping early data communication in response to a paging request;

FIG. 15 is a flow diagram of an example method in a RAN for receiving DL data for a UE and determining whether the RAN should page the UE in view of whether the UE is currently performing early data communication;

FIG. 16 is a flow diagram of an example method in a RAN for determining whether a UE should transition to the connected stated in view a request to resume a radio connection received from the UE;

FIG. 17 is a flow diagram of an example method in a UE for formatting an RRC message depending on whether the UE is transitioning to the connected state during an early data transmission procedure.

### DETAILED DESCRIPTION OF THE DRAWINGS

A base station of this disclosure performs early data communication with a UE and, upon detecting a certain event, transitions the UE to the connected state in which the radio resource control connection with the base station is active. As discussed below, the base station can be distributed, with a DU supporting the radio connection with the UE, and a CU communicating with a core network or an edge server.

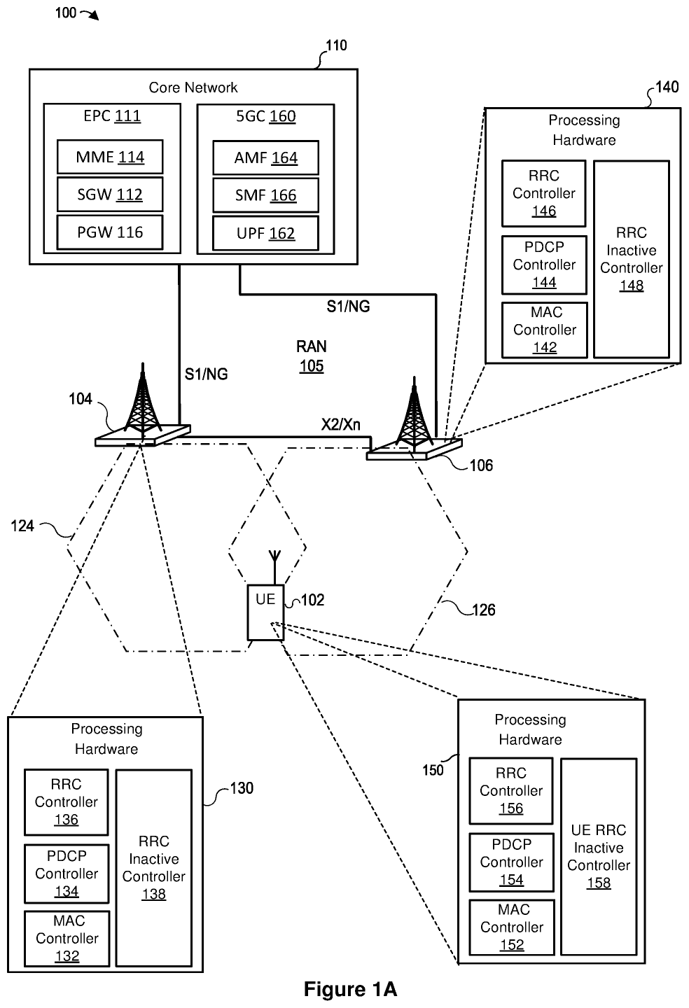

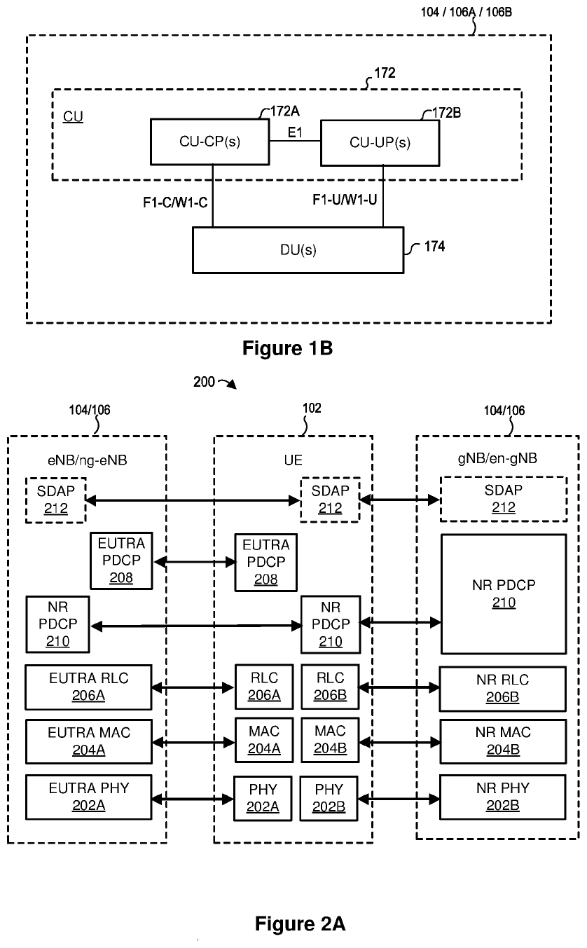

Referring first to FIG. 1A, an example wireless communication system 100 includes a UE 102, a base station (BS) 104, a base station 106, and a core network (CN) 110. The base stations 104 and 106 can operate in a RAN 105 connected to the core network (CN) 110. The CN 110 can be implemented as an evolved packet core (EPC) 111 or a fifth generation (5G) core (5GC) 160, for example. The CN 110 can also be implemented as a sixth generation (6G) core in another example.

The base station 104 covers a cell 124, and the base station 106 covers a cell 126. If the base station 104 is a gNB, the cell 124 is an NR cell. If the base station 124 is an ng-eNB, the cell 124 is an evolved universal terrestrial radio access (E-UTRA) cell. Similarly, if the base station 106 is a gNB, the cell 126 is an NR cell, and if the base station 126 is an ng-eNB, the cell 126 is an E-UTRA cell. The cells 124 and 126 can be in the same Radio Access Network Notification Areas (RNA) or different RNAs. In general, the RAN 105 can include any number of base stations, and each of the base stations can cover one, two, three, or any other suitable number of cells. The UE 102 can support at least a 5G NR (or simply, “NR”) or E-UTRA air interface to communicate with the base stations 104 and 106. Each of the base stations 104, 160 can connect to the CN 110 via an interface (e.g., S1 or NG interface). The base stations 104 and 106 also can be interconnected via an interface (e.g., X2 or Xn interface) for interconnecting NG RAN nodes.

Among other components, the EPC 111 can include a Serving Gateway (SGW) 112, a Mobility Management Entity (MME) 114, and a Packet Data Network Gateway (PGW) 116. The SGW 112 in general is configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management (AMF) 164, and/or Session Management Function (SMF) 166. Generally speaking, the UPF 162 is configured to transfer user-plane packets related to audio calls, video calls, Internet traffic, etc., the AMF 164 is configured to manage authentication, registration, paging, and other related functions, and the SMF 166 is configured to manage PDU sessions.

As illustrated in FIG. 1A, the base station 104 supports a cell 124, and the base station 106 supports a cell 126. The cells 124 and 126 can partially overlap, so that the UE 102 can select, reselect, or hand over from one of the cells 124 and 126 to the other. To directly exchange messages or information, the base station 104 and base station 106 can support an X2 or Xn interface. In general, the CN 110 can connect to any suitable number of base stations supporting NR cells and/or EUTRA cells.

As discussed in detail below, the UE 102 and/or the RAN 105 of this disclosure reduces latency in uplink transmission of data when the radio connection between the UE 102 and the RAN 105 is suspended, e.g., in the inactive or idle state of the protocol for controlling radio resources between the UE 102 and the RAN 105. For clarity, the examples below refer to the RRC_INACTIVE or RRC_IDLE state of the RRC protocol.

As used in this disclosure, the term “data” or “data packet” refers to signaling, control-plane information at a protocol layer of controlling radio resources (e.g., RRC), controlling mobility management (MM), controlling session management (SM), or refers to non-signaling, non-control-plane information at protocol layers above the layer of the protocol for controlling radio resources (e.g., RRC), above the layer of the protocol for controlling mobility management (MM), above the layer of the protocol for controlling session management (SM), or above the layer of the protocol for controlling quality of service (QOS) flows (e.g., service data adaptation protocol (SDAP)). The data to which the UE and/or the RAN applies the techniques of this disclosure can include for example Internet of things (IOT) data, Ethernet traffic data, Internet traffic data, or a short message service (SMS) message. Further, as discussed below, the UE 102 in some implementations applies these techniques only if the size of the data is below a certain threshold value.

In the example scenarios discussed below, the UE 102 transitions to the RRC_INACTIVE or RRC_IDLE state, then selects a cell of the base station 104, and exchanges data with the base station 104 either via the base station 106 or with the base station 104 directly, without transitioning to RRC_CONNECTED state. As a more specific example, after the UE 102 determines that data is available for uplink transmission in the RRC_INACTIVE or RRC_IDLE state, the UE 102 can apply one or more security functions to the UL data packet, generate a first UL protocol data unit (PDU) including the security-protected packet, include an uplink (UL) RRC message along with the first UL PDU in a second UL PDU, and transmit the second UL PDU to the RAN 105. The UE 102 includes a UE identity/identifier (ID) of the UE 102 in the UL RRC message. The RAN 105 can identify the UE 102 based on the UE ID. In some implementations, the UE ID can be an inactive Radio Network Temporary Identifier (I-RNTI), resume ID, or a non-access stratum (NAS) ID. The NAS ID can be a (5G)S-Temporary Mobile Subscriber Identity (S-TMSI) or a (5G) Global Unique Temporary Identifier (GUTI).

The security function can include an integrity protection and/or encryption function. When integrity protection is enabled, the UE 102 can generate a message authentication code for integrity (MAC-I) to protect integrity of the data. Thus, the UE 102 in this case generates a security-protected packet including the data and the MAC-I. When encryption is enabled, the UE 102 can encrypt the data to obtain an encrypted packet, so that the security-protected packet includes encrypted data. When both integrity protection and encryption are enabled, the UE 102 can generate a MAC-I for protecting integrity of the data and encrypt the data along with the MAC-I to generate an encrypted packet and an encrypted MAC-I. The UE 102 then can transmit the security-protected packet to the RAN 105, while in the RRC_INACTIVE or RRC_IDLE state.

In some implementations, the data is an uplink (UL) service data unit (SDU) of the packet data convergence protocol (PDCP) or SDAP. The UE 102 applies the security function to the SDU and includes the secured SDU in a first UL PDU (e.g., a UL PDCP PDU). The UE 102 then includes the UL PDCP PDU in a second UL PDU such as a UL MAC PDU, which can be associated with the medium access control (MAC) layer. Thus, the UE 102 in these cases transmits the secured UL PDCP PDU in the UL MAC PDU. In some implementations, the UE 102 can include, in the UL MAC PDU, a UL RRC message. In other implementations, the UE 102 may not include a UL RRC message in the UL MAC PDU. In this case, the UE 102 may not include a UE ID of the UE 102 in the UL MAC PDU not including a UL RRC message. In yet other implementations, the UE 102 can include the UL PDCP PDU in a UL radio link control (RLC) PDU and then include the UL RLC PDU in the UL MAC PDU. In the case of including the UL RRC message in the UL MAC PDU, the UE 102 in some implementations generates an RRC MAC-I and includes the RRC MAC-I in the UL RRC message. For example, the RRC MAC-I is a resumeMAC-I field, as specified in 3GPP specification 38.331. In other implementations, the UE 102 can obtain the RRC MAC-I from the UL RRC message with an integrity key (e.g., K_{RRCint} key), an integrity protection algorithm, and other parameters COUNT (e.g., 32-bit, 64-bit or 128-bit value), BEARER (e.g., 5-bit value) and DIRECTION (e.g., 1-bit value).

In other implementations, the data is an uplink (UL) protocol data unit (SDU) of the NAS. The UE 102 applies the security function to the SDU and includes the secured SDU in a first UL PDU such as a NAS PDU, which can be associated with the NAS layer. For example, the NAS layer can be MM sublayer or SM sublayer of 5G, Evolved Packet System (EPS) or 6G. Then the UE 102 can include the UL NAS PDU in a second UL PDU such as a UL RRC message. Thus, the UE 102 in these cases transmits the (first) secured UL NAS PDU in the UL RRC message. In some implementations, the UE 102 can include the UL RRC message in a UL MAC PDU and transmits the UL MAC PDU to a base station (e.g., base station 104 or 106) via a cell (e.g., cell 124 or 126). In this case, the UE 102 may not include an RRC MAC-I in the UL RRC message. Alternatively, the UE 102 may include an RRC MAC-I as described above.

In some implementations, the UL RRC message described above can be a common control channel (CCCH) message, an RRC resume request message or an RRC early data request message. The UL RRC message can include a UE ID of the UE 102 as described above.

More generally, the UE 102 can secure the data using at least one of encryption and integrity protection, include the secured data as a security-protected packet in the first UL PDU, and transmit the first UL PDU to the RAN 105 in the second UL PDU.

In some scenarios and implementations, the base station 106 can retrieve the UE ID of the UE 102 from the UL RRC message and identify the base station 104 as the destination of the data in the first UL PDU, based on the determined UE ID. In one example implementation, the base station 106 retrieves the first UL PDU from the second UL PDU and transmits the first UL PDU to the base station 104. The base station 104 then retrieves the security-protected packet from the first UL PDU, applies one or two security functions to decrypt the data and/or check the integrity protection, and transmits the data to the CN 110 (e.g., SGW 112, UPF 162, MME 114 or AMF 164) or an edge server. In some implementations, the edge server can operate within the RAN 105. More specifically, the base station 104 derives at least one security key from UE context information of the UE 102. Then the base station 104 retrieves the data from the security-protected packet by using the at least one security key and transmits the data to the CN 110 or edge server. When the security-protected packet is an encrypted packet, the base station 104 decrypts the encrypted packet to obtain the data by using the at least one security key (e.g., an (d)encryption key). If the security-protected packet is an integrity-protected packet, the integrity protected packet may include the data and the MAC-I. The base station 104 can verify whether the MAC-I is valid for the security-protected packet by using the at least one security key (e.g., an integrity key). When the base station 104 confirms that the MAC-I is valid, the base station 104 sends the data to the CN 110 or edge server. On the other hand, when the base station 104 determines that the MAC-I is invalid, the base station 104 discards the security-protected packet. Further, if the security-protected packet is both encrypted and integrity-protected, the encrypted and integrity-protected packet may include the encrypted packet along with the encrypted MAC-I. The base station 104 in this case decrypts the encrypted packet and the encrypted MAC-I to obtain the data and the MAC-I. The base station 104 then determines whether the MAC-I is valid for the data. If the base station 104 determines that the MAC-I is valid, the base station 104 retrieves the data and forwards the data to the CN 110 or edge server. However, if the base station 104 determines that the MAC-I is invalid, the base station 104 discards the packet.

In another implementation, the base station 106 retrieves the security-protected packet from the first UL PDU. The base station 106 performs a retrieve UE context procedure with the base station 104 to obtain UE context information of the UE 102 from the base station 104. The base station 106 derives at least one security key from the UE context information. Then the base station 106 retrieves the data from the security-protected packet by using the at least one security key and transmits the data to the CN 110 (e.g., UPF 162) or an edge server. When the security-protected packet is an encrypted packet, the base station 106 decrypts the encrypted packet to obtain the data by using the at least one security key (e.g., an (d)encryption key). If the security-protected packet is an integrity-protected packet, the integrity protected packet may include the data and the MAC-I. The base station 106 can verify whether the MAC-I is valid for the security-protected packet by using the at least one security key (e.g., an integrity key). When the base station 106 confirms that the MAC-I is valid, the base station 106 sends the data to the CN 110. On the other hand, when the base station 106 determines that the MAC-I is invalid, the base station 106 discards the security-protected packet. Further, if the security-protected packet is both encrypted and integrity-protected, the encrypted and integrity-protected packet may include the encrypted packet along with the encrypted MAC-I. The base station 106 in this case decrypts the encrypted packet and the encrypted MAC-I to obtain the data and the MAC-I. The base station 106 then determines whether the MAC-I is valid for the data. If the base station 106 determines that the MAC-I is valid, the base station 106 retrieves the data and forwards the data to the data CN 110. However, if the base station 106 determines that the MAC-I is invalid, the base station 106 discards the packet.

In other scenarios and implementations, the base station 104 can retrieve the UE ID of the UE 102 from the UL RRC message and identify that the base station 104 stores UE context information of the UE 102. Thus, the base station 104 retrieves the security-protected packet from the first UL PDU, retrieves the data from the security-protected packet and sends the data to the CN 110 or edge server as described above.

Further, the RAN 105 in some cases transmits data in the downlink (DL) direction to the UE 102 operating in the RRC_INACTIVE or RRC_IDLE state.

For example, when the base station 104 determines that data is available for downlink transmission to the UE 102 currently operating in the RRC_INACTIVE or RRC_IDLE state, the base station 104 can apply at least one security function to the data to generate a security-protected packet, generate a first DL PDU including the security-protected packet, and the first DL PDU in a second DL PDU. To secure the data, the base station 104 can apply the security function (e.g., integrity protection and/or encryption) to the data. More particularly, when integrity protection is enabled, the base station 104 generates a MAC-I for protecting integrity of the data, so that security-protected packet includes the data and the MAC-I. When encryption is enabled, the base station 104 encrypts the data to generate an encrypted packet, so that security-protected packet is an encrypted packet. Further, when both integrity protection and encryption are enabled, the base station 104 can generate a MAC-I for protecting integrity of the data and encrypt the data along with the MAC-I to generate an encrypted packet and an encrypted MAC-I. The base station 104 in some implementations generates a first DL PDU, such as a DL PDCP PDU, using the security-protected packet, includes the first DL PDU in a second DL PDU associated with the MAC layer for example (e.g., a DL MAC PDU), and transmits the second DL PDU to the UE 102 without first causing the UE 102 to transition from the RRC_INACTIVE or RRC_IDLE state to the RRC_CONNECTED state. In some implementations, the base station 104 includes the DL PDCP PDU in a DL RLC PDU, includes the DL RLC PDU in the DL MAC PDU and transmits the DL MAC PDU to the UE 102 without first causing the UE 102 to transition from the RRC_INACTIVE or RRC_IDLE state to the RRC_CONNECTED state.

In another implementation, the base station 104 transmits the first DL PDU to the base station 106, which then generates a second PDU (e.g., a DL MAC PDU) including the first DL PDU and transmits the second DL PDU to the UE 102 without first causing the UE 102 to transition from the RRC_INACTIVE or RRC_IDLE state to the RRC_CONNECTED state. In some implementations, the base station 106 generates a DL RLC PDU including the first DL PDU and includes the DL RLC PDU in the second DL PDU. In yet another implementation, the base station 104 includes the first DL PDU in a DL RLC PDU and transmits the DL RLC PDU to the base station 106, which then generate a second DL PDU (e.g., a DL MAC PDU) including the DL RLC PDU and transmits the second DL PDU to the UE 102.

In some implementations, the base station (i.e., the base station 104 or 106) generates a downlink control information (DCI) and a cyclic redundancy check (CRC) scrambled with an ID of the UE 102 to transmit the second DL PDU generated by the base station. In some implementations, the ID of the UE 102 can be a Radio Network Temporary Identifier (RNTI). For example, the RNTI can be a cell RNTI (C-RNTI), a temporary C-RNTI or an inactive C-RNTI. The base station transmits the DCI and scrambled CRC on a physical downlink control channel (PDCCH) to the UE 102 operating in the RRC_INACTIVE or RRC_IDLE state. The base station scrambles the CRC with the ID of the UE 102. In some implementations, the base station may assign the ID of the UE 102 to the UE 102 in a random access response that the base station transmits in a random access procedure with the UE 102 before transmitting the DCI and scrambled CRC. In other implementations, the base station may assign the ID of the UE 102 to the UE 102 in an RRC message (e.g., RRC release message or an RRC reconfiguration message) that the base station transmits to the UE 102 before transmitting the DCI and scrambled CRC, e.g., while the UE 102 was in the RRC_CONNECTED state.

The UE 102 operating in the RRC_INACTIVE or RRC_IDLE state can receive the DCI and scrambled CRC on the PDCCH. Then the UE 102 confirms that a physical downlink shared channel (PDSCH), including the second DL PDU, is addressed to the UE according to the ID of the UE 102, DCI, and scrambled CRC. The UE 102 then can retrieve the data from the security-protected packet. If the security-protected packet is an encrypted packet, the UE 102 can decrypt the encrypted packet using the appropriate decryption function and the security key to obtain the data. If the security-protected packet is the integrity-protected packet including the data and the MAC-I, the UE 102 can determine whether the MAC-I is valid. If the UE 102 confirms that the MAC-I is valid, the UE 102 retrieves the data. If, however, the UE 102 determines that the MAC-I is invalid, the UE 102 discards the packet. Finally, when the security-protected packet is both encrypted and integrity-protected, with encrypted data and an encrypted MAC-I, the UE 102 can decrypt the encrypted packet and encrypted MAC-I to obtain the data and the MAC-I. The UE 102 then can verify that the MAC-I is valid for the data. If the UE 102 confirms that the MAC-I is valid, the UE 102 retrieves and processes the data. Otherwise, when the UE 102 determines that the MAC-I is invalid, the UE 102 discards the data.

The base station 104 is equipped with processing hardware 130 that can include one or more general-purpose processors (e.g., CPUs) and a non-transitory computer-readable memory storing instructions that the one or more general-purpose processors execute. Additionally or alternatively, the processing hardware 130 can include special-purpose processing units. The processing hardware 130 in an example implementation includes a Medium Access Control (MAC) controller 132 configured to perform a random access procedure with one or more user devices, receive uplink MAC protocol data units (PDUs) to one or more user devices, and transmit downlink MAC PDUs to one or more user devices. The processing hardware 130 can also include a Packet Data Convergence Protocol (PDCP) controller 134 configured to transmit DL PDCP PDUs in accordance with which the base station 104 can transmit data in the downlink direction, in some scenarios, and receive UL PDCP PDUs in accordance with which the base station 104 can receive data in the uplink direction, in other scenarios. The processing hardware further can include an RRC controller 136 to implement procedures and messaging at the RRC sublayer of the protocol communication stack. The processing hardware 130 in an example implementation includes an RRC inactive controller 138 configured to manage uplink and/or downlink communications with one or more UEs operating in the RRC_INACTIVE or RRC_IDLE state. The base station 106 can include generally similar components. In particular, components 142, 144, 146, and 148 can be similar to the components 132, 134, 136, and 138, respectively.

The UE 102 is equipped with processing hardware 150 that can include one or more general-purpose processors such as CPUs and non-transitory computer-readable memory storing machine-readable instructions executable on the one or more general-purpose processors, and/or special-purpose processing units. The processing hardware 150 in an example implementation includes an RRC inactive controller 158 configured to manage uplink and/or downlink communications when the UE 102 operates in the RRC_INACTIVE state. The processing hardware 150 in an example implementation includes a Medium Access Control (MAC) controller 152 configured to perform a random access procedure with a base station, transmit uplink MAC protocol data units (PDUs) to the base station, and receive downlink MAC PDUs from the base station. The processing hardware 150 can also include a PDCP controller 154 configured to transmit DL PDCP PDUs in accordance with which the base station 106 can transmit data in the downlink direction, in some scenarios, and receive UL PDCP PDUs in accordance with which the base station 106 can receive data in the uplink direction, in other scenarios. The processing hardware further can include an RRC controller 156 to implement procedures and messaging at the RRC sublayer of the protocol communication stack.

FIG. 1B depicts an example, distributed or disaggregated implementation of any one or more of the base stations 104, 106. In this implementation, the base station 104, 106 includes a central unit (CU) 172 and one or more DUs 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include a PDCP controller, an RRC controller and/or an RRC inactive controller such as PDCP controller 134, 144, RRC controller 136, 146 and/or RRC inactive controller 138, 148. In some implementations, the CU 172 can include a radio link control (RLC) controller configured to manage or control one or more RLC operations or procedures. In other implementations, the CU 172 does not include an RLC controller.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a MAC controller (e.g., MAC controller 132, 142) configured to manage or control one or more MAC operations or procedures (e.g., a random access procedure), and/or a RLC controller configured to manage or control one or more RLC operations or procedures. The process hardware can also include a physical layer controller configured to manage or control one or more physical layer operations or procedures.

In some implementations, the CU 172 can include a logical node CU-CP 172A that hosts the control plane part of the PDCP protocol of the CU 172. The CU 172 can also include logical node(s) CU-UP 172B that hosts the user plane part of the PDCP protocol and/or Service Data Adaptation Protocol (SDAP) protocol of the CU 172. The CU-CP 172A can transmit control information (e.g., RRC messages, F1 application protocol messages), and the CU-UP 172B can transmit the data packets (e.g., SDAP PDUs or Internet Protocol packets).

The CU-CP 172A can be connected to multiple CU-UP 172B through the E1 interface. The CU-CP 172A selects the appropriate CU-UP 172B for the requested services for the UE 102. In some implementations, a single CU-UP 172B can be connected to multiple CU-CP 172A through the E1 interface. The CU-CP 172A can be connected to one or more DU 174s through an F1-C interface. The CU-UP 172B can be connected to one or more DU 174 through the F1-U interface under the control of the same CU-CP 172A. In some implementations, one DU 174 can be connected to multiple CU-UP 172B under the control of the same CU-CP 172A. In such implementations, the connectivity between a CU-UP 172B and a DU 174 is established by the CU-CP 172A using Bearer Context Management functions.

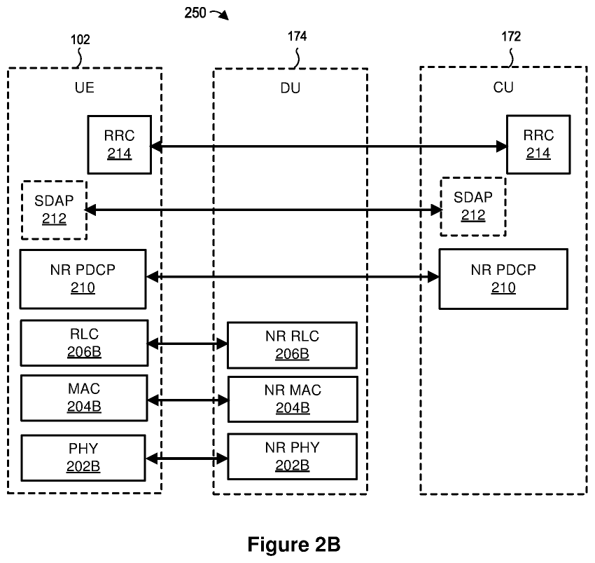

FIG. 2A illustrates, in a simplified manner, an example protocol stack 200 according to which the UE 102 can communicate with an eNB/ng-eNB or a gNB (e.g., one or more of the base stations 104, 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to an EUTRA PDCP sublayer 208 and, in some cases, to a NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to Service Data Adaptation Protocol (SDAP) 212 or a radio resource control (RRC) sublayer (not shown in FIG. 2). The UE 102, in some implementations, supports both the EUTRA and the NR stack as shown in FIG. 2, to support handover between EUTRA and NR base stations and/or to support DC over EUTRA and NR interfaces. Further, as illustrated in FIG. 2, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) or RRC sublayer (not shown in FIG. 2) to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 can be SDAP PDUS, Internet Protocol (IP) packets or Ethernet packets.

FIG. 2B illustrates, in a simplified manner, an example protocol stack 250 which the UE 102 can communicate with a DU (e.g., DU 174) and a CU (e.g., CU 172). The radio protocol stack 200 is functionally split as shown by the radio protocol stack 250 in FIG. 2B. The CU at any of the base stations 104 or 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to RRC 214, and NR PDCP 210 provides DRBs to SDAP 212 and SRBs to RRC 214.

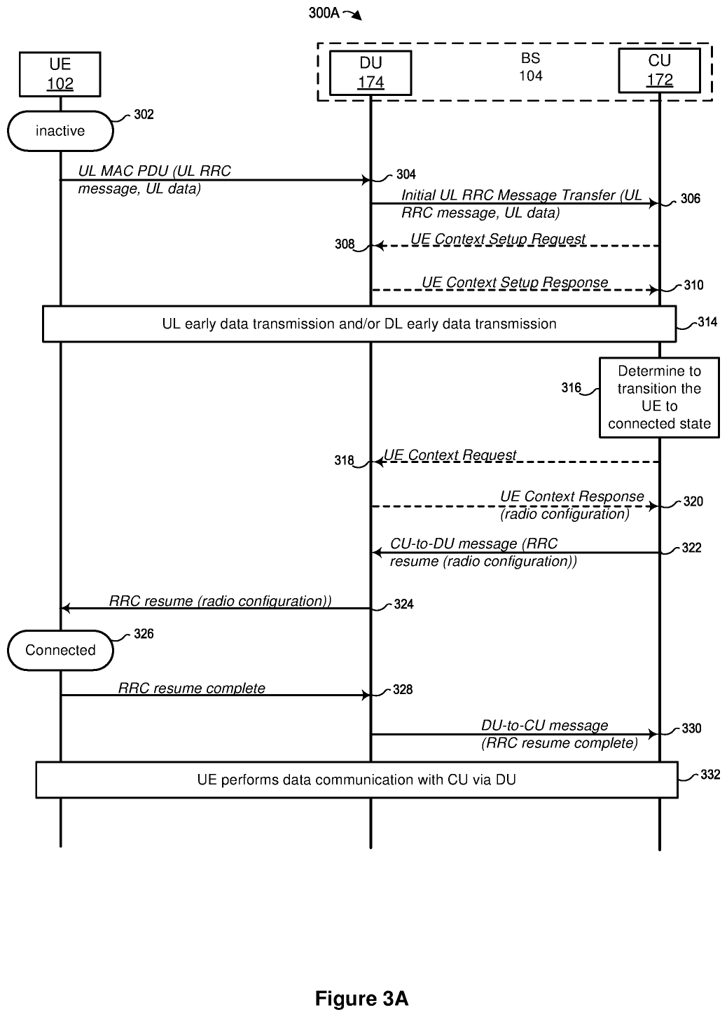

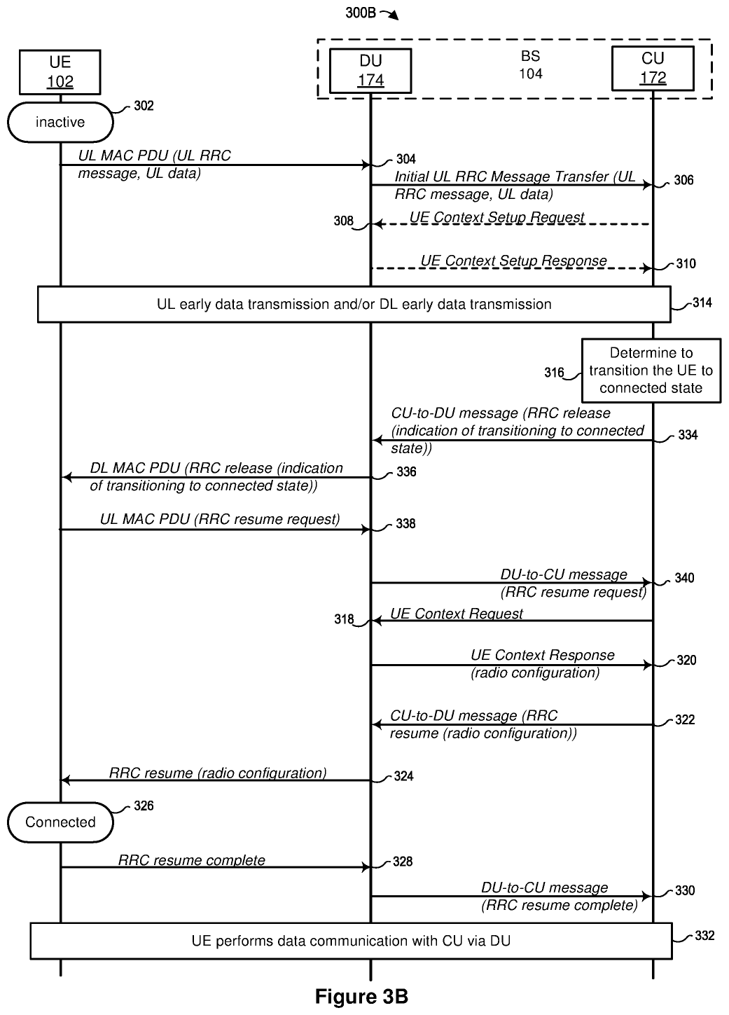

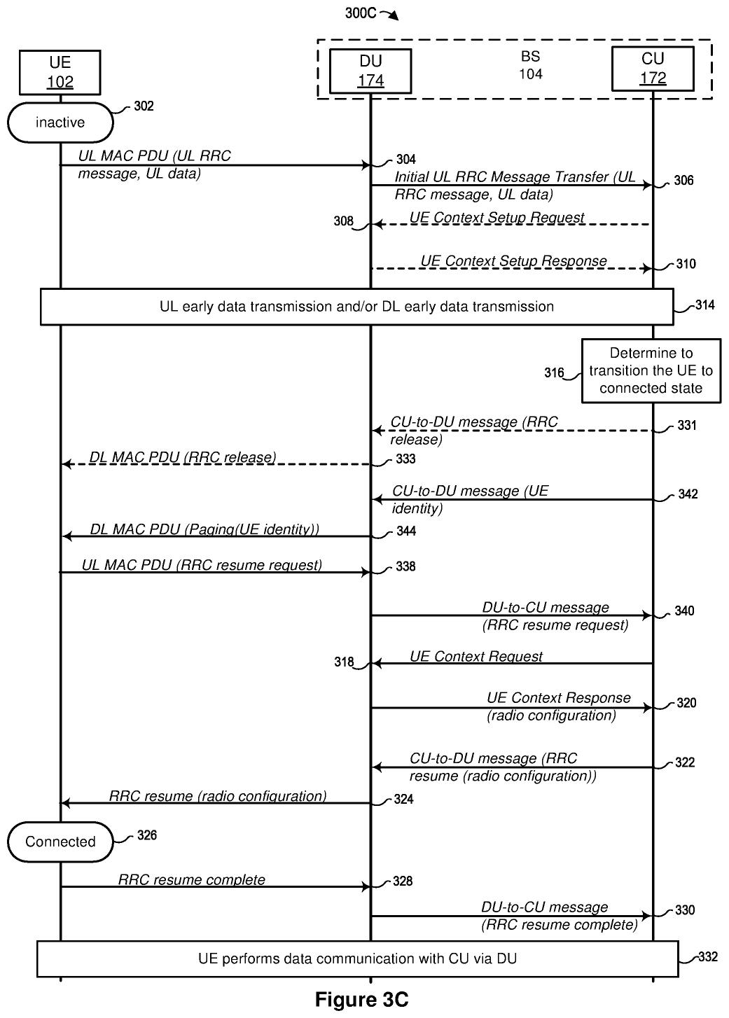

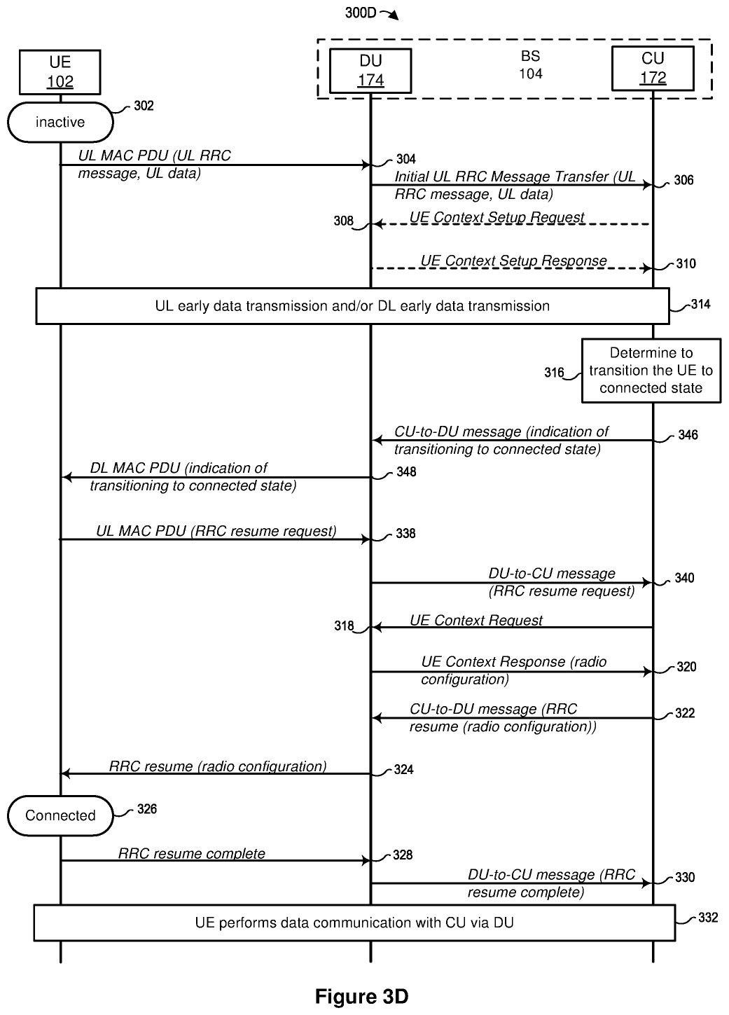

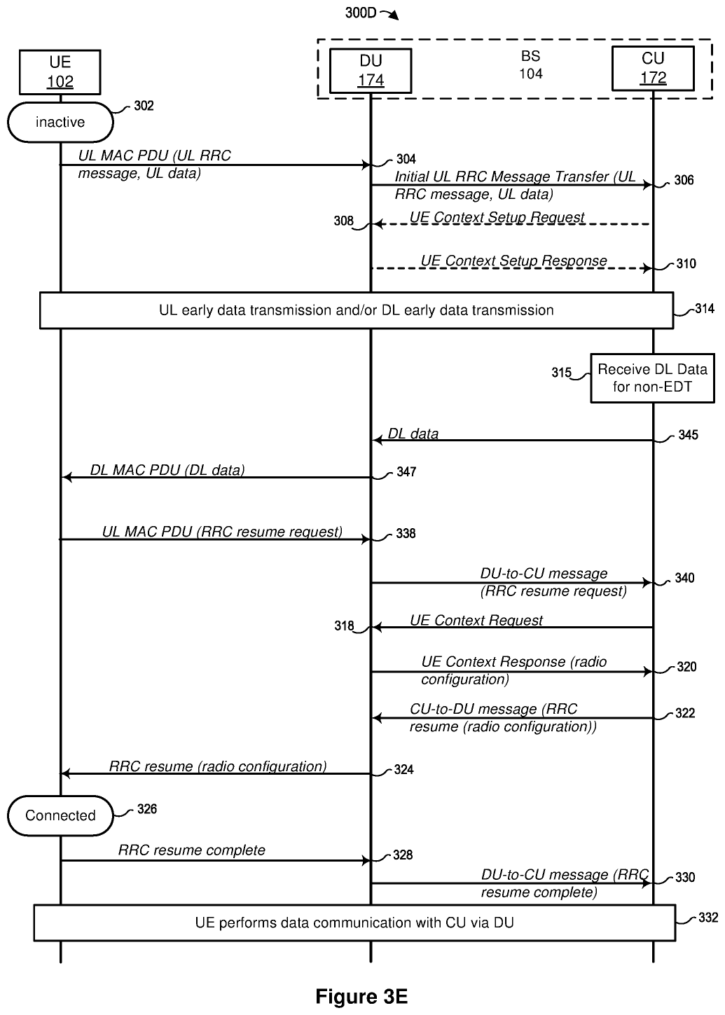

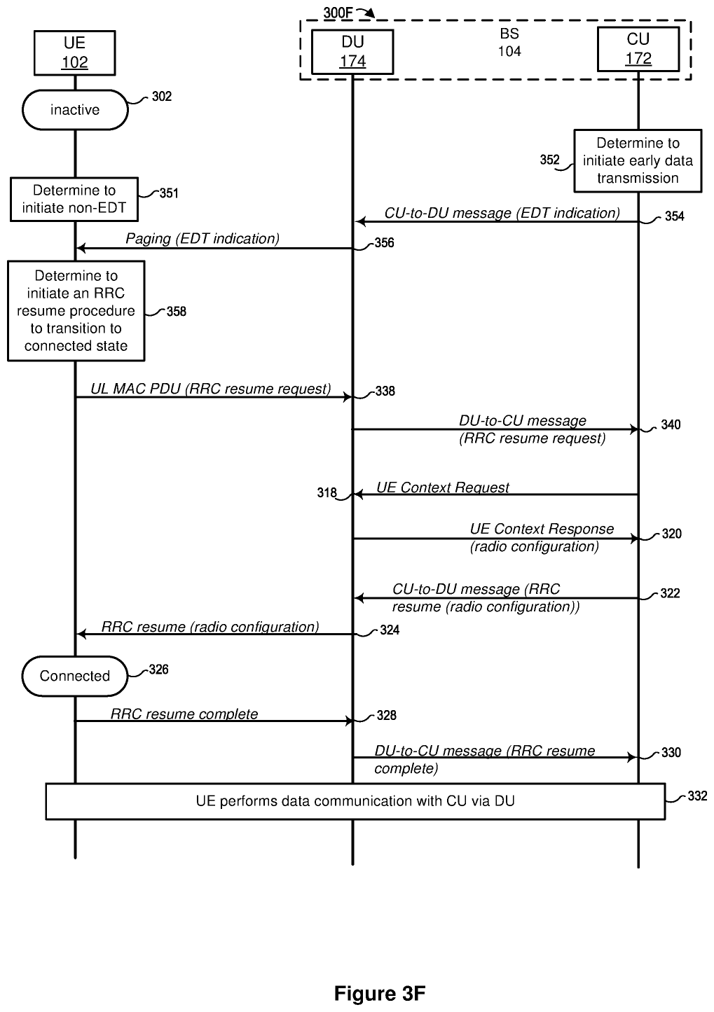

Next, several example scenarios that involve several components of FIG. 1A and relate to transmitting and/or receiving data in an inactive or idle state are discussed with reference to FIGS. 3A-3F. Generally speaking, events in FIGS. 3A-3F that are the same are labeled with the same reference numbers. To simplify the following description, the “inactive state” can represent the RRC_INACTIVE or RRC_IDLE state, and the connected state can represent the RRC_CONNECTED state.

Referring first to FIG. 3A, in a scenario 300A, the UE 102 initially operates 302A in an inactive state with the base station 104 including a CU 172 and a DU 174. In some scenarios and implementations, the UE 102 operates in a connected state with the RAN 105 (e.g., the base station 104, base station 106 or another base station not shown in FIG. 1A) prior to operating 302 in the inactive state. After a certain period of data inactivity for the UE 102, the RAN 105 can determine that neither the RAN 105 nor the UE 102 has transmitted any data in the downlink direction or the uplink direction, respectively, during the (first) certain period. In response to the determination, the RAN 105 can transmit a first RRC release message (e.g., RRCRelease message or RRCConnectionRelease message) to the UE 102 and instruct the UE 102 to transition to the inactive state. The UE 102 transitions to the inactive state upon receiving the first RRC release message. The RAN 105 can assign an I-RNTI or a resume identity/identifier (ID) to the UE 102 and include the assigned value in the first RRC release message. After the UE 102 transitions to the inactive state, the UE 102 may perform one or more RAN notification area (RNA) updates with the CU 172 via the DU 174 without state transitions, in some cases. For example, the UE 102 in the inactive state can send a RRC resume request message (e.g., a RRCResumeRequest message or RRCConnectionResumeRequest message) to the RAN 105 for an RNA update and the RAN 105 can transmit a first RRC release message (e.g., RRCRelease message or RRCConnectionRelease message) to the UE 102 and instruct the UE 102 to still stay in the inactive state.

At a later time, the UE 102 in the inactive state initiates early data communication to transmit uplink (UL) data or receive downlink (DL) data. In cases of transmitting UL data while the UE 102 is in the inactive state, the early data communication can be mobile originating (MO) early data transmission (EDT). In cases of receiving DL data while the UE 102 is in the inactive state, the early data communication can be mobile terminating (MT) EDT (i.e., early data reception from the viewpoint of the UE 102). In such cases, the UE 102 at event 302 receives from the DU 174 a paging message, which includes a UE ID of the UE 102 and an EDT indication. The UE ID can be an I-RNTI, resume ID, or a NAS ID (e.g., S-TMSI or 5G-S-TMSI). In response to the paging message (i.e., the UE ID and the EDT indication), the UE 102 initiates early data communication to receive DL data from the DU 174 and CU 172.

In response to or after initiating early data communication, the UE 102 generates an initial UL MAC PDU including a UL RRC message and transmits 304 the initial UL MAC PDU to the DU 174 on cell 124. The DU 174 retrieves the UL RRC message and the UL data from the initial UL MAC PDU and generates an Initial UL RRC Message Transfer message including the UL RRC message and the UL data. Then, the DU 174 sends 306 the Initial UL RRC Message Transfer message to the CU 172. In cases of MO early data transmission, the UE 102 can include UL data in the initial UL MAC PDU, and the DU 174 retrieve the UL data from the initial UL MAC PDU. In such cases, the DU 174 can include the UL data in the Initial UL RRC Message Transfer message. Alternatively, the DU 174 can send the UL data to the CU 172 separately. After receiving the Initial UL RRC Message Transfer message, the CU 172 in some implementations can send 308 a UE Context Setup Request message to the DU 174 to establish a UE Context of the UE 102 at the DU 174. In response, the DU 174 sends 310 a UE Context Setup Response message to the CU 172.

After receiving the Initial UL RRC Message Transfer message or the UE Context Setup Response message, the CU 172 refrains from transitioning the UE 102 to a connected state and performs 314 early data communication with the CU 172 via the DU 174 to communicate UL data and/or DL data. In some implementations, the (UL/DL) data at event 304 or 314 can include at least one data packet for an application or a protocol layer. In such implementations, the UE 102 at event 314 can transmit to the DU 174 one or more UL MAC PDU where each can include a particular data packet or a particular segment of a data packet, and/or the DU 174 at event 314 can receive one or more data packets from the CU 172 and transmits one or more DL MAC PDU where each can include a particular data packet or a particular segment of a data packet. When the DU 174 receives all segments of a data packet from the UE 102, the DU 174 assembles the segments to obtain the data packet, and send the data packet to the CU 172. When the UE 102 receives all segments of a data packet from the DU 174, the UE 102 assembles the segments to obtain the data packet.

In some implementations, the UL data at event 304 can be a segment of a particular data packet for an application or a protocol layer. In such implementations, the UE 102 at event 314 can transmit other segment(s) of the particular data packet to the DU 174. When the DU 174 receives all segments of a data packet from the UE 102, the DU 174 assembles the segments to obtain the data packet, and send the data packet to the CU 172. After the DU 174 obtains the data packet, the DU 174 generates an Initial UL RRC Message Transfer message including the UL RRC message and the data packet and send 306 the Initial UL RRC Message Transfer message.

In some example scenarios, the protocol layer can be a mobility management (MM) layer (e.g., 5G MM), a session management (SM) layer (e.g., 5G SM), an LTE positioning protocol (LPP) layer or a secure user-plane location (SUPL) protocol layer. The data packet can comprise an Internet Protocol (IP) packet, an Ethernet packet, or an application packet. In other scenarios, the data packet is a PDCP PDU that includes an RRC PDU, a MM PDU, a SM PDU, LPP PDU, an IP packet, an Ethernet packet, or an application packet. Still further, the data packet in some scenarios can be an RRC PDU including a NAS PDU, such that the NAD PDU includes an IP packet, an Ethernet packet, or an application packet. In some implementations, the UE 102 can determine whether the UL data qualifies for transmission in the inactive state in view of one or more of such factors as whether the data is an IMS packet, whether the UL data is associated with a radio bearer (e.g., DRB or SRB) not suitable or configured for early data transmission, whether the UL data is an NAS message for initiating a particular NAS procedure, the size of the data, etc. When the UE 102 determines that the data does not qualify for transmission in the inactive state, the UE 102 can perform an RRC procedure (e.g., RRC connection establishment procedure or RRC resume procedure) to transition to the connected state.

After performing 314 early data communication with the UE 102 via the DU 174, the CU 172 determines 316 to transition the UE 102 to the connected state. In response to the determination, the CU 172 can send 318 a UE Context Request message to the DU 174 to obtain a radio configuration for the UE 102. In response, the DU 174 sends 320 a UE Context Response including a radio configuration for the UE 102. In some implementations, the UE Context Request message and UE Context Response message can be a UE Context Setup Request message and a UE Context Setup Response message respectively. In other implementations, the UE Context Request message and UE Context Response message can be a UE Context Modification Request message and a UE Context Modification Response message respectively. After obtaining the radio configuration, the CU 172 generates a RRC resume message including the radio configuration and sends 322 to the DU 174 a CU-to-DU message including the RRC resume message. In turn, the DU 174 retrieves the RRC resume message from the CU-to-DU message and sends 324 the RRC resume message to the UE 102.

In some implementations, the CU 172 can apply one or more security functions to the RRC resume message (i.e., the RRC PDU including the RRC resume message), generate a DL PDCP PDU including the security protected RRC resume message and sends 322 the CU-to-DU message including the DL PDCP PDU to the DU 174. In turn, the DU 174 sends 324 at least one DL MAC PDU including the DL PDCP PDU to the UE 102. In one implementation, the DU 174 can generate a DL MAC PDU including the DL PDCP PDU and transmit the DL MAC PDU to the UE 102. More specifically, the DU 174 can generate a DL RLC PDU including the DL PDCP PDU, include the DL RLC PDU in a DL MAC PDU and transmit 324 the DL MAC PDU to the UE 102. In another implementation, the DU 174 can segment the DL PDCP PDU into multiple segments and generate plural DL MAC PDUs where each includes a particular segment. When the UE 102 receives all of the segments, the UE 102 assembles the segments to obtain the DL PDCP PDU. More specifically, the DU 174 can generate a DL RLC PDU segment including a particular segment of the DL PDCP PDU, include the DL RLC PDU segment into a DL MAC PDU and transmit 324 the DL MAC PDU to the UE 102. When the UE 102 receives all of the DL RLC PDU segments, the UE 102 assembles the segments to obtain the DL PDCP PDU.

In response to the RRC resume message, the UE 102 transitions 326 to the connected state and transmits 328 a RRC resume complete message to the DU 174, which in turn sends 330 a DU-to-CU message including the RRC resume complete message to the CU 172. After the UE 102 transitions to the connected state, the UE 102 performs 332 data communication with the CU 172 via the DU 174.

In some implementations, the UE 102 can apply one or more security functions to the RRC resume complete message (i.e., the RRC PDU including the RRC resume complete message), generate a UL PDCP PDU including the security protected RRC resume complete message and send 328 the UL PDCP PDU to the DU 174, which in turn sends 330 the DU-to-CU message including the UL PDCP PDU to the CU 172. In one implementation, the UE 102 can generate a UL MAC PDU including the UL PDCP PDU and transmit the UL MAC PDU to the UE 102. The DU 174 retrieves the UL PDCP PDU from the UL MAC PDU. More specifically, the UE 102 can generate a UL RLC PDU including the UL PDCP PDU, include the UL RLC PDU in a UL MAC PDU and transmit 328 the UL MAC PDU to the DU 174. The DU 174 retrieves the UL PDCP PDU from the UL MAC PDU and the UL RLC PDU. In another implementation, the UE 102 can segment the UL PDCP PDU into multiple segments and generate plural MAC PDUs each including a particular segment. When the DU 174 receives all of the segments, the DU 174 assembles the segments to obtain the UL PDCP PDU. More specifically, the UE 102 can generate a UL RLC PDU segment including a particular segment of the UL PDCP PDU, include the UL RLC PDU segment into a UL MAC PDU and transmit 328 the UL MAC PDU to the DU 174. When the DU 174 receives all of the UL RLC PDU segments, the DU 174 assembles the segments to obtain the UL PDCP PDU.

In some implementations, if the CU 172 receives a radio configuration in the UE Context Setup Response message that the DU 174 transmits at event 310 and determines the radio configuration is valid for the UE 102, the CU 172 may not send 318 the UE Context Request message and includes the radio configuration in the RRC resume message.

Now referring to FIG. 3B, the CU 172 in a scenario 300B behaves differently from scenario 300A when it transmits, to the UE 102, a release command with an explicit indication that the UE should transition to the connected state. In particular, after determining 316 to transition the UE 102 to the connected state, the CU 172 generates an RRC release message with an explicit indication that the UE 102 should transition to connected state. The CU 172 transmits 334 the RRC release message in a CU-to-DU message to the DU 174, which then forwards 336 the RRC release message to the UE 102 via the radio interface.

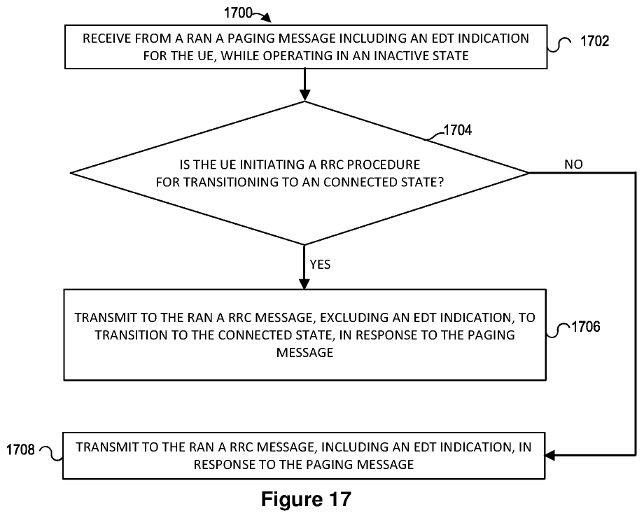

The UE 102 receives 336 the indication that the UE should transition to the connected state and, in response, transmits 338 an RRC resume request to the DU 102. The RRC resume request in some cases includes a cause value other than EDT, as discussed with reference to FIG. 17. In any case, the DU 174 can transmit 340, to the CU 172, a DU-to-CU message enclosing the RRC resume request. The DU-to-CU message can be similar to the Initial UL RRC Message Transfer of event 306, a UL RRC Message Transfer message, or a UE Context Modification Required message, for example. The UE 102, the DU 174, and the CU 172 then continue to configure a radio connection similar to the scenario of FIG. 3A discussed above.

FIG. 3C illustrates an example scenario 300C in which the CU 172 initiates paging of the UE 102 so as to cause the UE 102 to transition to the connected state. After the determination 316, the CU 172 in some implementations transmits 331, to the DU 174, a CU-to-DU message including an RRC release command The DU 174 then transmits the RRC release command to the UE 102 in a DL MAC PDU. In another implementation, the CU 172 omits the transmission 331 and proceeds directly to event 342.

To page the UE 102, the CU 172 transmits 342 the UE identity to the DU 174 in a CU-to-DU message, and the DU 172 initiates 344 paging of the UE 102 via another DL MAC PDU. The UE 102 responds 338 with an UL MAC PDU enclosing an RRC resume request, which the DU 174 forwards 340 to the CU 172. The scenario 300C then proceeds similar to the scenarios 300A and 300B discussed above.

Referring to FIG. 3D, a scenario 300D is similar to the scenario 300B of FIG. 3B, but here the CU 172 transmits 346 an explicit indication that the UE 102 should transition to connected state as an element of the CU-to-DU message rather than in an RRC message, and the DU 174 accordingly transmits this indication as an element of a DL MAC PDU. It is noted that transmitting the indication in an RRC message provides additional security because the RRC message is encrypted.

In a scenario 300E of FIG. 3E, the CU 172 receives non-EDT DL data for the UE and transmits at least a portion of the DL data during the EDT procedure, and the UE 102 then requests that the CU 172 resume the radio connection. In particular, the CU 172 can receive DL data for the UE 102 from the CN 110 or an edge server. The DL data may not be specifically associated with EDT, but the CU 172 can transmit 345 the DL data to the UE 102 without configuring a new radio bearer or a QoS. Thus, the CU 172 can process the new DL data similar to EDT DL data of procedure 314. After the DU 174 forwards 347 the DL data to the UE 102 in a DL MAC PDU, the UE 102 may transmit 338 an RRC resume request to the DU 102 and proceed as previously described with reference to FIG. 3B. In this manner, the CU 172 can cause the UE 102 to initiate a transition to the connected state by transmitting one or more non-EDT DL data packets.

Now referring to FIG. 3F, in an example scenario 300F, the UE 102 operating 302 in the inactive state determines 351 to initiate a non-EDT session. Meanwhile, the CU 172 determines 352 to initiate early data transmission and transmits 354 a CU-to-DU message including an EDT indication. The DU 174 then forwards 356 the EDT indication in a paging message to the UE 102. The UE 102 determines 358 that it should initiate an RRC resume procedure and transitions to the connected state as previously described with reference to FIG. 3B. The UE 102 in this case thus selects the non-EDT approach despite the EDT indication from the base station 104.

Several example methods that can be implemented in the UE 102, the RAN 105, or one of the network nodes 172, 174 are discussed next. Each of these methods can be implemented as a set of instructions stored on a computer-readable medium and executable by processing hardware such as one or more processors.

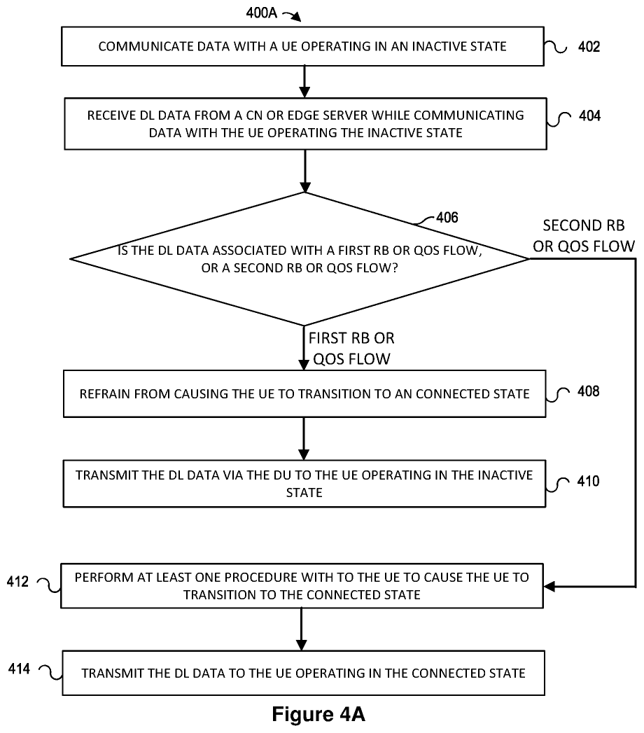

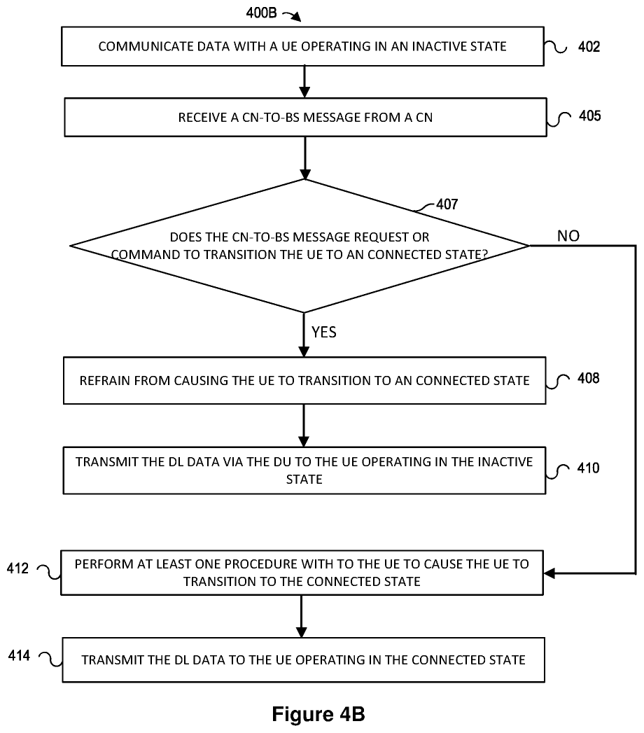

Referring first to FIG. 4A, a method 400A can be implemented in the CU 172 or another suitable CU. The method 400A begins at block 402, where the CU communicates data with a UE operating in an active state. The CU thus performs an early data communication procedure. The communication can involve uplink and/or downlink data. At block 404, the CU receives DL data from a core network or an edge server, before completing the early data communication procedure.

At block 406, the CU determines whether the DL data belongs to, or is otherwise associated with, a particular radio bearer (RB) or a particular QoS flow. Some RBs and QoS flow are supportable through EDT and others require a connected state. When the CU determines that the DL data is associated with a certain RB or a certain QoS flow supportable through EDT, the CU executes block 408 followed by block 410. Otherwise, when the CU determines that the DL data is associated with another RB or another QoS flow that requires a connected state, the CU executes block 412 followed by block 414.

At block 408, the CU refrains from causing the UE to transition to the connected state and, at block 410, transmits the DL data to the UE while the UE continues to operate in the inactive state. Thus, the CU at blocks 408 and 410 continues the early data communication session. On the other hand, at block 412, the CU initiates at least one procedure (e.g., paging, RRC resume) to transition the UE to the connected state. At block 414, the CU transmits the DL data to the operating in the connected state. Thus, according to the method 400A, the CU determines whether the CU should transition from the inactive state to the connected state in view of the RB or QoS flow with which DL data is associated.

FIG. 4B is a flow diagram of an example method 400B in which the CU determines whether it should transition the UE to the connected state in view of the content of a CN-to-BS message. In particular, after receiving CN-to-BS message at block 405, the CU determines at block 407 whether the message includes a request or instruction to transition the UE to the connected state. The CU performs blocks 408 and 410 in response to determining that the CN-to-BS message includes such an instruction, and performs blocks 412 and 414 otherwise.

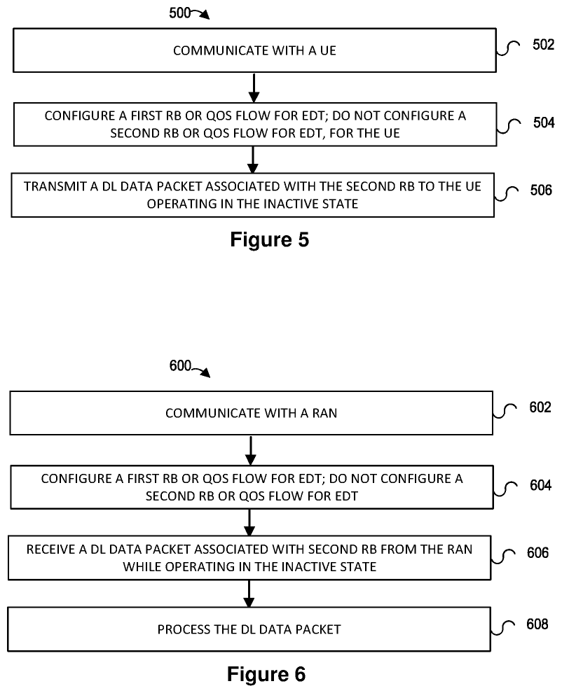

Now referring to FIG. 5, the CU of this disclosure also can implement a method 500 for transmitting DL data to the UE during early data communication. At block 502, the CU communicates with the UE using early data communication. At block 504, the CU configures a certain (first) RB or QoS flow for EDT, but does not configure another (second) RB or QoS flow for EDT. The CU transmits, at block 506, a DL data packet associated with the second RB or QoS flow to the UE while the UE continues to operate in the inactive state (sec, for example, events 315, 345, and 347 in FIG. 3E). Thus, the CU can effectively reclassify a DL data packet for EDT to avoid an unnecessary transition to the connected state: more specifically, the CU can transmit an originally non-EDT DL data to the UE as EDT DL data.

FIG. 6 illustrates an example method 600 for processing DL data during early data communication, which can be implemented in a UE. At block 502, the UE communicates with the RAN using early data communication. At block 604, the UE configures a certain (first) RB or QoS flow for EDT, but does not configure another (second) RB or QoS flow for EDT. The UE receives, at block 606, a DL data packet associated with the second RB or QoS flow from RAN while the UE continues to operate in the inactive state (see, for example, events 315, 345, and 347 in FIG. 3E). The UE then processes the DL data packet at block 608. In this manner, the UE can receive an originally non-EDT DL data from the RAN as EDT DL data.

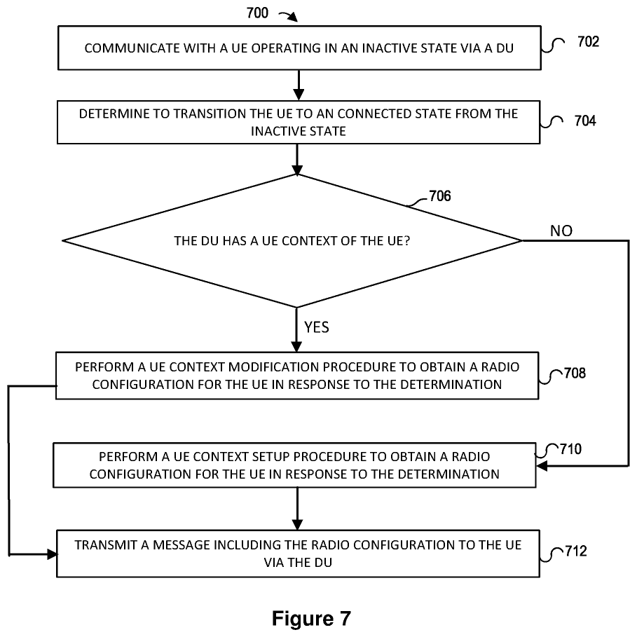

Now referring to FIG. 7, an example method 700 for obtaining radio resources for a UE can be implemented in the CU of this disclosure. At block 702, the CU communicates with the UE operating in an inactive state. At block 704, the CU determines that the UE should transition to the connected state. Next, at block 706, the CU determines whether the DU stores a context for the UE and, if so, proceeds to block 708, where the CU performs a procedure for UE context modification to obtain a radio configuration for the UE. Otherwise, if the CU determines that the DU currently has no context for the UE, the flow proceeds to block 710, where the CU performs a procedure for setting up a context for the UE. The CU obtains a radio configuration for the UE during the UE context setup procedure. The flow proceeds from block 708 or 710 to block 712, where the CU transmits a message including the radio configuration to the UE.

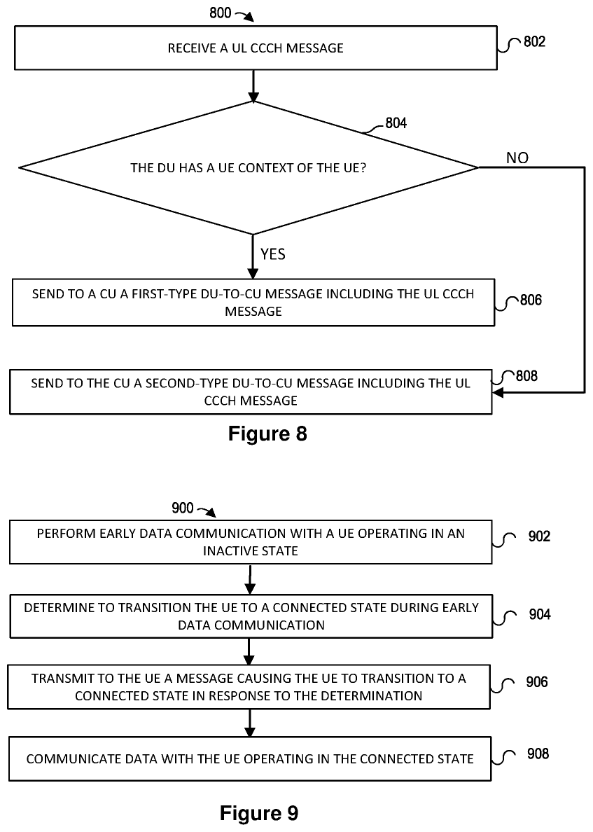

FIG. 8 is a flow diagram of an example method 800 according to which a DU selects an uplink message for communication with a CU in view of whether the DU has a context for the UE. At block 802, the DU receives a UL message from a UE over a Common Control Channel (CCCH). Thus, the DU receives a message while the UE operates in an inactive state. If the DU determines at block 804 that the DU currently stores a context for the UE, the flow proceeds to block 806, where the DU transmits a first type of a DU-to-CU message including the UL CCCH message. The message can be, for example, a UL RRC Message Transfer. However, if the DU determines at block 804 that the DU currently does not have a context for the UE, the flow proceeds to block 808, where the DU transmits a second type of a DU-to-CU message including the UL CCCH message. This message can be, for example, an Initial UL RRC Message Transfer message (sec, e.g., event 306 in FIG. 3D).

Next, FIG. 9 is a flow diagram of an example method 900, which a CU can implement to instruct the UE to transition to the connected state during early data communication. At block 902, the CU performs early data communication with a UE. At block 904, the CU determines that the UE should transition to the connected state. The CU then transmits 906 to the UE a message that causes the UE to transition to the connected state. At block 908, the CU communicates data with the UE operating in the connected state.

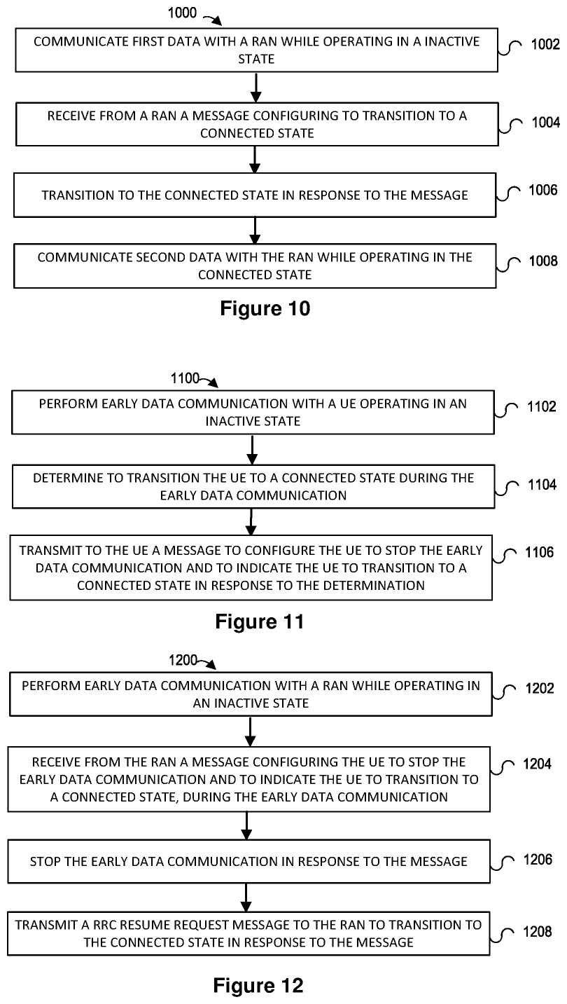

FIG. 10 is a flow diagram of an example method 1000 which a UE can implement to transition to the connected state after early data communication and continue communication in the connected state. At block 1002, the UE communicates first data with a RAN while operating in an inactive state. The UE thus uses an early data communication procedure. At block 1004, the UE receives a command from the RAN to transition to the connected state, and the UE accordingly transitions to the connected state at block 1006. Then, at block 1008, the UE communicates second data with the RAN while operating in the connected state.

Referring to FIG. 11, a CU can implement a method 1100 to instruct the UE to transition to the connected state as well as stop early data communication. At block 1102, the CU performs early data communication with the UE. The CU determines, at block 1104, that the UE should transition to the connected state. At block 1106, the CU transmits a message to the UE, indicating that the UE should transition to the connected state as well as stop the early data communication (see, for example, event 336 in FIG. 3B).

FIG. 12 next illustrates a flow diagram of a corresponding example method 1200 in a UE. At block 1202, the UE performs early data communication with the RAN. The UE receives, at block 1204, a message, indicating that the UE should transition to the connected state as well as stop the early data communication (see, for example, event 336 in FIG. 3B). The UE stops the early data communication at block 1206 and transmits a request to resume the RRC connection at block 1208, both in response to the message received at block 1204.

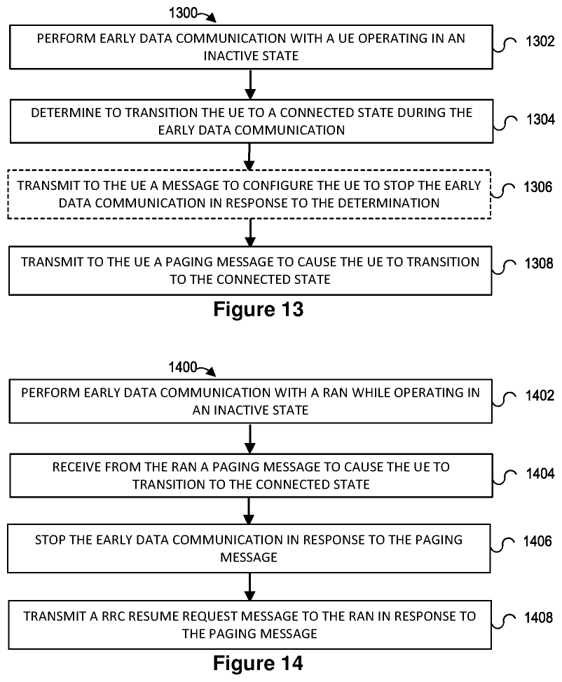

On the other hand, a method 1300 of FIG. 13 allows the CU to instruct the UE separately regarding the state transition and the early data communication. At block 1302, the CU performs early data communication with the UE. The CU determines, at block 1304, that the UE should transition to the connected state. At block 1306, the CU transmits a message to the UE, indicating that the UE should stop early data communication (see, for example, event 331 of FIG. 3C). At block 308, the CU transmits a paging message to the UE to indicate that the UE should transition to the connected state (see, for example, event 342 in FIG. 3C). In some implementations, the CU does not execute block 1306.

FIG. 14 for clarity illustrates a corresponding method implemented in a UE. At block 1402, the UE performs early data communication with the RAN. At block 1404, the UE receives a paging message, indicate that the UE should transition to the connected state and, at block 1406, the UE stops early data communication in response to the paging message. At block 1408, the UE transmits a request to resume the RRC connection, also in response to the paging message received at block 1404. In some implementations, the UE at block 1404 may transition to the connected state based on other factors. For example, the UE can send a RRC resume request message to resume the RRC connection. Alternatively, the UE can at block 1408 transmit a RRC setup request message to transition to the connected state in response to the paging message, instead of the RRC resume request message.

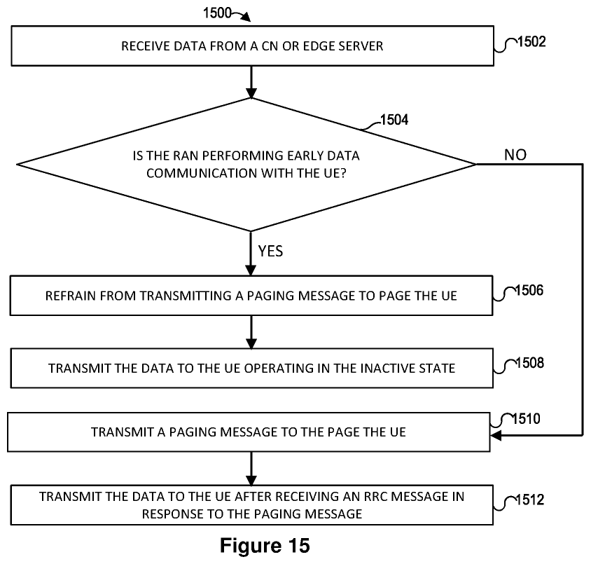

FIG. 15 is a flow diagram of an example method 1500 in a RAN for receiving DL data for a UE and determining whether the RAN should page the UE. At block 1502, the RAN receives data from a CN or an edge server. At block 1504, the RAN determines whether early data communication with the UE is in progress. If so, the flow proceeds to block 1506, where the RAN refrains from transmitting a paging message to the UE and transmits, at block 1508, DL data to the UE using the early data communication mechanism. Otherwise, the flow proceeds to block 1510, where the RAN transmits a paging message to the UE and, at block 1512, transmits DL data to the UE only after receiving an RRC message in response to the paging message. This message can be, for example, a request to resume the RRC connection.

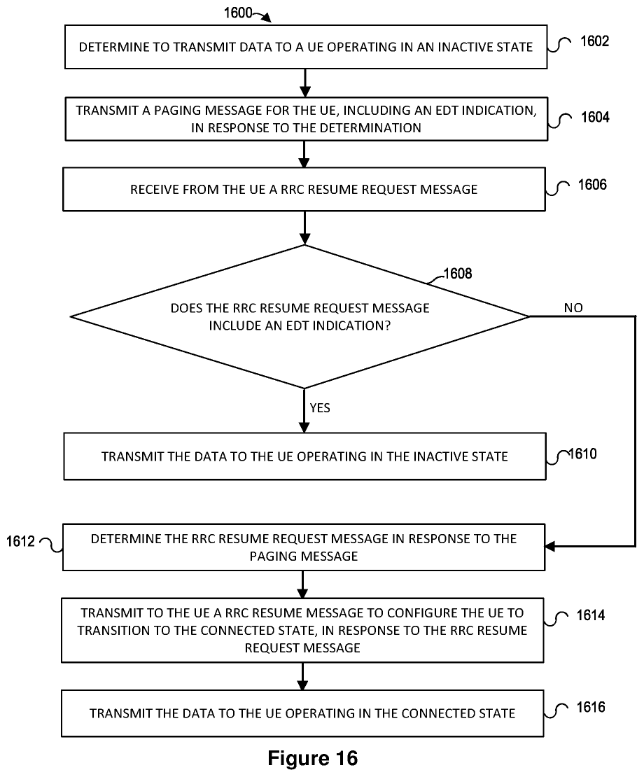

Next, FIG. 16 is a flow diagram of an example method 1600 in a RAN for determining whether a UE should transition to the connected stated in view a request to resume a radio connection received from the UE. At block 1602, the RAN determines that it should transmit data to the UE, while the UE is operating in an active state. At block 1604, the RAN transmits a paging request and includes an EDT indication. After receiving an RRC resume request from the UE at block 1606, the RAN determines whether the RRC resume requests includes an EDT indication. If the EDT indication is present in the received message, the flow proceeds to block 1610, where the RAN transmits the data to the UE operating in the inactive state. Otherwise, the flow proceeds to block 1612, where the RAN determines that the RRC resume request message is responsive to the paging request and, at block 1614, transmits an RRC resume message to cause a transition to the connected state at the UE.

Thus, according to the method 1600, the RAN complies with the preference of the UE regarding EDT or non-EDT transmission (see, for example, FIG. 3F).

Finally, FIG. 17 is a flow diagram of an example method 1700 in a UE for formatting an RRC message depending on whether the UE is transitioning to the connected state during an early data transmission procedure. At block 1702, the UE receives a paging message from the RAN including an EDT indication. If the UE determines, at block 1704, that the UE is initiating an RRC procedure for transitioning to the connected state, the flow proceeds to block 1706, where the UE transmits an RRC message without an EDT indication, to the RAN. Otherwise, at block 1708, the UE transmits an RRC message with an EDT indication, in response to the paging message.

Thus, according to the method 1700, the UE asserts its preference with respect to EDT or non-EDT transmission, to the RAN (see, for example, FIG. 3F).

The following additional considerations apply to the foregoing discussion.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IOT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

The following list of examples reflects a variety of the embodiments explicitly contemplated by the present disclosure:

Example 1. A method, in a central unit (CU) of a distributed base station, for managing data communication between a UE and a distributed unit (DU) of the distributed base station, the method comprising: performing, by processing hardware, early data communication with the UE; determining, by the processing hardware and during the early data communication, that the UE should have an active radio resource control connection with the DU; obtaining, by the processing hardware from the DU, a radio configuration for the UE; and transmitting, by the processing hardware via the DU, the radio configuration to the UE.

Example 2. The method of example 1, further comprising: receiving, during the early data communication, downlink (DL) data addressed to the UE; wherein the determining is based at least in part on the receiving.

Example 3. The method of example 2, wherein the determining is further based on a radio bearer (RB) with which the DL data is associated.

Example 4. The method of example 2 or 3, wherein the determining is further based on a quality of service (QOS) with which the DL data is associated.

Example 5. The method of example 3 or 4, wherein the determining, the obtaining, and the transmitting occur in a first instance; the method further comprising, in a second instance: determining, based on at least one of the RB or the QoS, that the UE does not require an active radio resource control connection with the DU to receive the DL data, and transmitting, by the processing hardware, the DL data to the UE using the early data communication.

Example 6. The method of example 1, further comprising: receiving, during the early data communication, a message from a core network or an edge server, the message related to the UE; wherein the determining is based at least in part on the message.

Example 7. The method of example 6, wherein the determining is further based on whether the message includes a request to activate the active radio resource control connection between the UE and the distributed base station.

Example 8. The method of example 6, wherein the determining, the obtaining, and the transmitting occur in a first instance; the method further comprising, in a second instance: determining, based on the message, that the UE does not require an active radio resource control connection to receive further DL data, and transmitting, by the processing hardware, the further DL data to the UE using the early data communication.

Example 9. The method of example 1, further comprising: receiving, during the early data communication from the UE, a request to resume the radio resource control connection; wherein the determining is based at least in part on the request.

Example 10. The method of example 9, further comprising: initiating, during the early data transmission, paging of the UE; wherein the request to activate the radio resource control connection is received in response to the paging.

Example 11. The method of example 10, wherein the determining is further based on whether the request includes an early data transmission (EDT) indication.

Example 12. The method of any of the preceding examples, wherein the obtaining includes: performing, by the processing hardware, a procedure for retrieving a context for the UE from the DU.

Example 13. The method of example 12, wherein the performing includes: transmitting, to the DU, a request for the context; and receiving, from the DU, the context including the radio configuration.

Example 14. The method of example 13, further comprising: performing, after receiving an initial data packet and prior to receiving subsequent data packets during the early data communication, a procedure to set up the context for the UE.

Example 15. The method of example 12, wherein the performing includes: transmitting, to the DU, a request to modify a context for the UE; and receiving, from the DU, the context including the radio configuration.

Example 16. The method of example 12, wherein the performing includes: transmitting, to the DU, a request to set up a new context for the UE; and receiving, from the DU, the new context including the radio configuration.

Example 17. The method of example 12, wherein performing the procedure for retrieving the UE context includes selecting the procedure based on whether the DU currently has the context for the UE.

Example 18. The method of any of the preceding examples, further comprising: transmitting, to the UE via the DU, an indication that the UE should transition to a connected state in which the radio resource control connection is active.

Example 19. The method of example 18, wherein transmitting the indication includes: transmitting the indication in a release command associated with a protocol for controlling radio resources.

Example 20. The method of example 19, including: determining to transmit the release command in response to a decision to refresh security parameters associated with the radio resource control connection.

Example 21. The method of example 18, wherein transmitting the indication includes: transmitting the indication in a command dedicated to transitioning the UE to the connected state, the command associated with a protocol for controlling radio resources.

Example 22. The method of example 18, wherein transmitting the indication includes: transmitting the indication in a medium access control (MAC) protocol data unit (PDU).

Example 23. The method any of examples 1-17, further comprising: transmitting, to the UE, a release command associated with a protocol for controlling radio resources; and initiating, by the processing hardware, paging of the UE.

Example 24. The method any of example 1-17, further comprising: receiving, by the processing hardware, non-EDT DL data addressed to the UE, the non-EDT DL data not associated with the early data communication; transmitting, to the UE via the DU, the non-EDT DL data; and receiving, from the UE, a request to resume the radio resource control connection, in response to the DL data.

Example 25. The method of example 24, wherein transmitting the non-EDT DL data includes: configuring a new RB or QoS for the non-EDT DL data.

Example 26. The method of any of the preceding examples, further comprising: operating CU as an integrated access and backhaul (IAB)-donor; wherein the DU operates an IAB-node.

Example 27. A method, in a distributed unit (DU) of a distributed base station, for facilitating uplink data communication between a UE and a central unit (CU) of the distributed base station, the method comprising: receiving, by processing hardware, a control-plane message from the UE; determining, by the processing hardware, whether the DU stores a context for the UE; and selecting, based on the determining, a first or a second type of a DU-to-CU message; and transmitting, by the processing hardware to the CU, the control-plane message in the selected type of the DU-to-CU message.

Example 28. The method of example 27, wherein the control-plane message is an UL Common Control Channel (CCCH) message.

Example 29. The method of example 27 or 28, wherein the selecting includes: selecting the Initial UL RRC Message Transfer type in response to determining that the DU stores the context.

Example 30. The method of example 27 or 28, wherein the selecting includes: selecting the RRC Message type in response to determining that the DU does not store the context.

Example 31. A network node comprising processing hardware and configured to implement a method according to any of the preceding examples.

Example 32. A method in a UE for processing a paging request from a radio access network (RAN), the method comprising: receiving, by processing hardware from the RAN and when the UE does not have an active radio resource control connection with the RAN, a paging request during the early data communication, the request including an early data transmission (EDT) indication; in a first instance, in response to determining that the UE is initiating a procedure to transition to a connected state in which the radio resource control connection with the RAN is active: omitting, from a message responsive to the paging request, the EDT indication; in a second instance, in response to determining that the UE is not initiating the procedure to transition to the connected state: including, in the message, the EDT indication; and transmitting, by the processing hardware, the message to the RAN.

Example 33. The method of example 32, wherein the paging request and the message responsive to the paging request conform to the radio resource control (RRC) protocol.

What is claimed is:

1. A method in a base station for managing data communication with a UE, the method comprising:
performing, by processing hardware, early data communication with the UE operating in an inactive state;
determining, by the processing hardware and during the early data communication, that the UE should transition to a connected state; and
transmitting, by the processing hardware and in response to the determining, to the UE, a message that causes the UE to transition to the connected state.

2. The method of claim 1, wherein performing the early data communication includes performing mobile-originating (MO) early data communication.

3. The method of claim 1 or 2, further comprising:
subsequently to the transmitting, communicating with the UE operating in the connected state.

4. The method of any of the preceding claims, further comprising:
receiving, during the early data communication, downlink (DL) data addressed to the UE;
wherein the determining is based at least in part on the receiving.

5. The method of claim 4, wherein:
the determining is further based on a radio bearer (RB) with which the DL data is associated.

6. The method of claim 4 or 5, wherein:
the determining is further based on a quality of service (QOS) with which the DL data is associated.

7. The method of any of the preceding claims, wherein transmitting the message includes transmitting an RRC resume message to the UE.

8. The method of any of the preceding claims, wherein:
the base station is a distributed base station, and
the method is implemented in a central unit (CU) of the base station.

9. A method, in a distributed unit (DU) of a distributed base station, for facilitating uplink data communication between a UE and a central unit (CU) of the distributed base station, the method comprising:
receiving, by processing hardware, a control-plane message from the UE;
selecting, when the DU stores a context for the UE, a first type of a DU-to-CU message;
otherwise selecting, when the DU does not store the context for the UE, a second type of the DU-to-CU message; and
transmitting, by the processing hardware to the CU, the control-plane message in the selected type of the DU-to-CU message.

10. The method of claim 9, wherein the control-plane message is an UL Common Control Channel (CCCH) message.

11. The method of claim 9 or 10, wherein receiving the control-plane message includes receiving uplink data associated with early data transmission.

12. The method of claim 27 or 28, wherein the selecting includes:
selecting the Initial UL RRC Message Transfer type in response to determining that the DU stores the context.

13. The method of claim 27 or 28, wherein the selecting includes:
selecting the RRC Message type in response to determining that the DU does not store the context.

14. A network node comprising processing hardware and configured to implement a method according to any of the preceding claims.

15. A method in a UE for managing data communication with a Radio Access Network (RAN), the method comprising:
communicating, by processing hardware, first data with the RAN, during early data communication while operating in an inactive state;
receiving, by the processing hardware from the RAN and during the early data communication, a message instructing the UE to transition to a connected state; and
transitioning, by the processing hardware, to the connected state in response to receiving the message.

16. The method of claim 15, wherein receiving the message includes receiving an RRC resume message.

17. A UE comprising processing hardware and configured to implement a method according to claim 15 or 16.
